(19) United States
(12) Patent Application Publication
(10) Pub. No.: US 2006/0274713 A1
(43) Pub. Date: Dec. 7, 2006

(54) METHODS OF CHANNEL ACCESS IN A MESHED NETWORK

(75) Inventors: APARNA PANDEY, CHICAGO, IL (US); RANDY L. EKL, LAKE ZURICH, IL (US); ROBERT D. LOGALBO, ROLLING MEADOWS, IL (US); CHRISTOPHER G. WARE, CHICAGO, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/421,085

(22) Filed: May 31, 2006

Related U.S. Application Data
(60) Provisional application No. 60/686,739, filed on Jun. 2, 2005.

(51) Int. Cl. H04J 3/16; H04L 12/403

(52) U.S. Cl. 370/346; 370/449

(57) ABSTRACT

Methods for providing a client access to a channel in a meshed wireless local area network are disclosed. The methods comprise that a client in the meshed wireless local area network implement a polling based channel access methodology. The client determines that the channel is available by sensing that the channel is not busy and sends a request for access to the channel to an access point, wherein the request specifies a priority of data that is to be transmitted when the client is granted access to the channel. The client waits a time period before receiving at least one of a) a rejection of the request for access to the channel, b) access to the channel, c) modification of the request for access to the channel, and d) delay access to the channel.

### FIELD OF THE INVENTION

The present invention relates Generally to wireless communication systems and in particular to the field of channel access in meshed wireless local area networks.

### BACKGROUND OF THE INVENTION

In a meshed wireless local area network (WLAN), there are wireless stations, either clients or access points (APs), which are in wireless communication with each other. In general when a first wireless station wishes to communicate with a second wireless station, the first wireless station must first access the radio frequency (RE) channel to send the communication to the second wireless station. Institute of Electrical and Electronics Engineers (IEEE) 802.11 specifies a channel access procedure termed Hybrid Coordination Function Controlled Channel Access (HCCA) that is polling based. Using the HCCA procedure, the first wireless station can utilize the channel for communicating with the second wireless station. However, since the wireless stations in the meshed WLAN are power constrained devices and will support bursty data traffic, having HCCA provide a power savings mechanism and at the same time support bursty traffic is useful so that the time that the wireless stations are awake awaiting to be polled is minimized, without the need to predict the traffic characteristics of bursty traffic.

Accordingly, there exists a need for an improved channel access method in meshed networks.

### BRIEF DESCRIPTION OF THE FIGURES

A preferred embodiment on the invention is now described, by way of example only, with reference to the accompanying in which:

FIG. 1 is an example block diagram illustrating a typical meshed wireless local area network system in accordance with an embodiment of the invention.

FIG. 2 is a message diagram illustrating a method for channel access in a meshed wireless local area network in accordance with an embodiment of the invention.

FIG. 3 is a message diagram illustrating another method for channel access in a meshed wireless local area network in accordance with an embodiment of the invention.

FIG. 4 is a frame format for a request for channel access in accordance with an embodiment of the invention.

FIG. 5 is a frame format for a response to the request of FIG. 4 in accordance with an embodiment of the invention.

FIG. 6 is a frame format for a Quality of Service Information Element as shown in FIGS. 4 and 5 in accordance with an embodiment of the invention.

FIG. 7 is a frame format for a Request Delay Information Element in accordance with an embodiment of the invention.

It will be appreciated that for simplicity and clarity of illustration, elements shown in the figures have not necessarily been drawn to scale. For example, the dimensions of some of the elements are exaggerated relative to each other. Further, where considered appropriate, reference numerals have been repeated among he figures to indicate identical elements.

### DETAILED DESCRIPTION

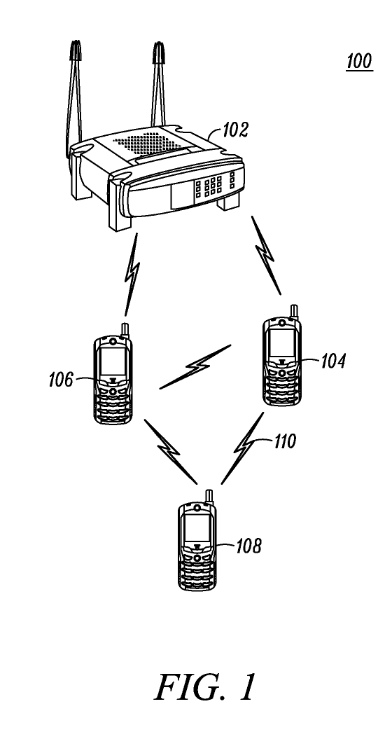

An embodiment of the present invention is described with reference to FIG. 1. Shown in FIG. 1 is a meshed wireless local area network (WLAN) 100 having a single access point (AP) 102 and multiple clients 104, 106, 108. The AP 102 provides access to a wired network (not shown) either directly or indirectly, e.g. via a tiered network of many more APs. All communications in the meshed WLAN are sent on a single frequency, namely one channel 110. The AP and all the clients utilize the one channel 110 to communicate with each other. Thus, each of the clients 104, 106, 108 and the AP 102 communicate with each other on the one channel 110.

Even though the clients of the meshed WLAN 100 are shown randomly, the clients and/or APs of the meshed WLAN 100 may be considered to be tiered. That is, a tier 1 client, e.g. client 104, communicates directly with the AP for access to the wired network (not shown) or for access to the rest of the WLAN communications hierarchy. In a second tier, a tier 2 client, e.g. client 108, communicates indirectly with the AP for access to the wired network (not shown) or for access to the rest of the wireless WLAN communications hierarchy where indirectly means that the tier 2 client communicates with a tier I client directly and the tier I client forwards the tier 2 client communications to the AP.

As will be appreciated by those of skill in the art, the clients may be any suitable type of wireless communications device capable of communicating within an ad-hoc network, such as computers, personal data assistants (PDAs), fixed mounted devices, vehicular mounted devices, or handheld devices, as well as others. Certain of the clients may also be connected to a fixed communications infrastructure, if desired.

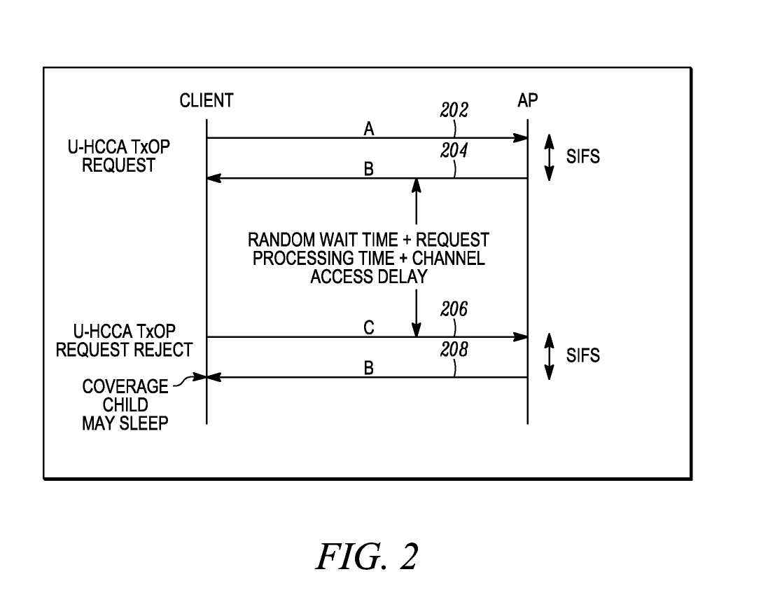

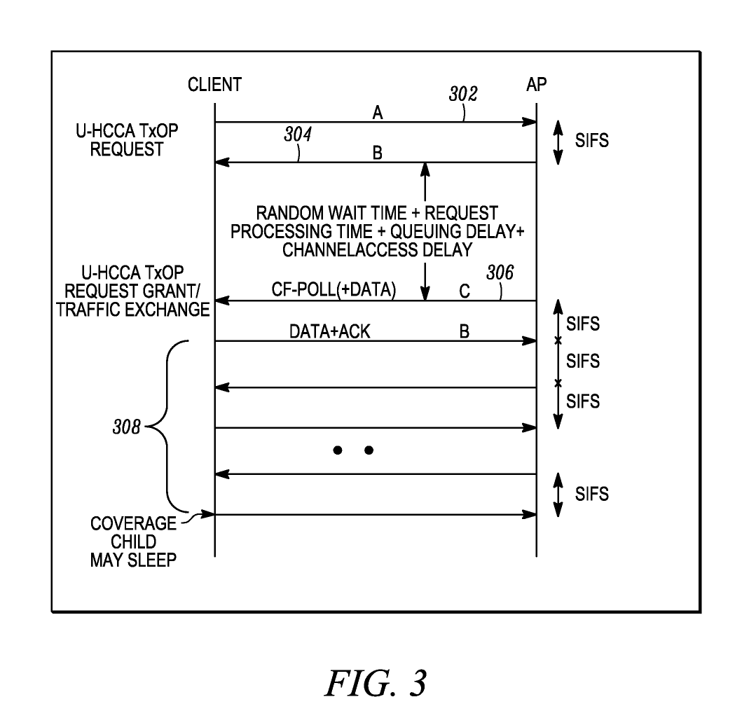

A method for accessing the channel in the meshed WLAN 100 according to an embodiment of the present invention will now be described with reference to the message flow diagrams of FIGS. 2 and 3. By way of example. FIG. 2 illustrates the message flow between a client, e.g. client 104, and an AP, e.g. AP 102, where the client requests access to the channel and the AP rejects access to the channel. Similarly, FIG. 3 illustrates the message flow between a client. e.g. client 104 and an AP, e.g. AP 102 where the client requests access to the channel and the client is granted access to the channel. In one embodiment, the AP explicitly grants access to the client and in another embodiment, the client is granted access to the channel when the AP sends data to the client. In any case, the client has access to the channel. As used herein, in one embodiment, references to messages 202 and 302, references to messages 204 and 304, and references to messages 206 and 306 are interchanged because the messages have the same message format. In one embodiment, the messages are not interchanged. For example, messages 206 and 306 convey different information as is described below.

Referring to FIG. 2, in operation, when a client has upstream data to transmit to the AP or when it has downstream data to retrieve from the AP, the client transmits a request 202 for a transmission opportunity (TxOP). As shown in FIG. 2, the request 202 is termed message A. In one embodiment, the request 202 is valid for a specified time period. e.g. one or more beacon intervals where a beacon interval is defined as the time between consecutive beacons and a beacon is defined as a message transmitted by the AP periodically at predetermined time instances. The client request 202 is a request for a polled transmission opportunity (TxOP) of a given priority. In one embodiment, the priority is based upon the priority of the upstream and/or downstream traffic that the request 202 is associated with. For example, if the client has high priority upstream data to transmit to the AP, then the request 202 comprises information relating to the high priority

In one embodiment, the request 202 is transmitted using contention-based techniques known in IEEE 802.11-based standards, where contention-based means that the clients and the AP randomly back off (based on priority) and contend for the channel. By the nature of the contention scheme described in IEEE 802.11-based standards, higher priority requests get transmitted earlier than lower priority requests. In one embodiment, requests of higher priority are processed at the AP before requests of lower priority.

In a further embodiment, the request 202 may also comprise a duration where the duration that the client requests is based on the data that it needs to transmit, e.g. its buffered upstream data. In another embodiment, the duration that the client requests is statically configured and does not adapt to the data in the meshed WLAN 100. In yet another embodiment, the duration that the client requests is unspecified because the client does not have knowledge of the required duration, e.g. if there is any downstream data to be delivered. In such an embodiment, sending a duration that is unspecified further informs the AP that the client does not having upstream data to transmit and requesting downstream data to be transmitted. In yet another embodiment, the request comprises a queue size.

Upon receiving the request 202, the AP acknowledges 204 the request and queues this request along with received requests to determine which requests to accept and which to reject. As shown in FIG. 2, the acknowledgement 204 is termed message B. The AP processes the request 202 to determine whether the request should be accepted or rejected. The time between transmitting the acknowledgement 204 and transmitting a response 206, 306 comprises one or more of the following delays: queuing delay (e.g. delay incurred by requests queued up at the AP to be processed by the AP), request processing time (e.g. time required for the AP to evaluate the request to determine if it should be accepted/rejected/modified), channel access delay (e.g. time required by the AP to access the channel using contention-based methods) and a random wait time. In one embodiment, the random wait time depends on one or more of a) the priority of the received request 202, 302, b) a number of queued requests and c) the time available at the AP to allocate TxOPs to all accepted requests. For example, if a low priority request 202, 302 is received, the random wait time may be long enough to accommodate the channel access delay of a higher priority request. Further, as the number of queued requests increase and/or the time available at the AP to allocate TxOPs decreases, the random wait time also decreases.

Upon determining that the request should be rejected, the AP transmits the reject response 206, so that the client can transition to power save. For example, if the AP does not have any downstream data to transmit, then the AP will send a reject response 206. As shown in FIG. 2, the reject response 706 is termed message C. Then, the client acknowledges 208 the determined response and transitions to power save. As shown in FIG. 2, the acknowledgement 208 is termed message B and is the same type as acknowledgement 204.

Similarly, granting access to the channel begins the same way. First the client requests 302 a polled transmission opportunity (TxOP) of a given priority from the AP (also termed message A). In one embodiment, the request also comprises a duration. Upon receiving the request, the AP acknowledges 304 (also termed message B) the request and queues this request along with other received requests to determine which requests to accept and which to reject. Upon determining that the request should be granted, the AP transmits a grant response 306 (also termed message C). In one embodiment, the grant response 306 is a different message than the reject response 206. As mentioned above, message 206 and message 306 are similar messages in one embodiment, e.g. where explicit request grant takes place, and different in one embodiment, e.g. where implicit grant takes place as shown in FIG. 3. As such, in one embodiment, the grant (306) need not be signaled explicitly by the AP granting a given client the requested TxOP by polling the client and sending the client data 308. As shown in FIG. 3, the poll and data communications are shown as a series of exchanges of data and acknowledgements 308. After receiving and acknowledging the data 308, the client transitions to power save.

In one embodiment, if a client does not receive an explicit reject response, e.g. 206 (also termed message C), then the client shall stay awake till either a client receives a directed poll message, then the client may transition to power save after the polling. Further, in one embodiment, the requested TxOP can also be used to deliver downstream traffic to the client. Otherwise, the client may send a new request 202 to the AP.

In one embodiment, there may be proprietary signaling, e.g. messages sent between the AP and the client, which takes place to assist the client in accessing the channel. For example, the messages A, B, and C may be messages that are extensions of IEEE 802.11 and are not a part of the standard. In another embodiment, some or all of the messages A, B, and C may adhere to the IEEE 802.11 standard and others may be proprietary. In any case, having the messages A, B, and C is useful in allowing the client to save power and allowing the client to sleep when the client is not a part of communications in the meshed WLAN 100.

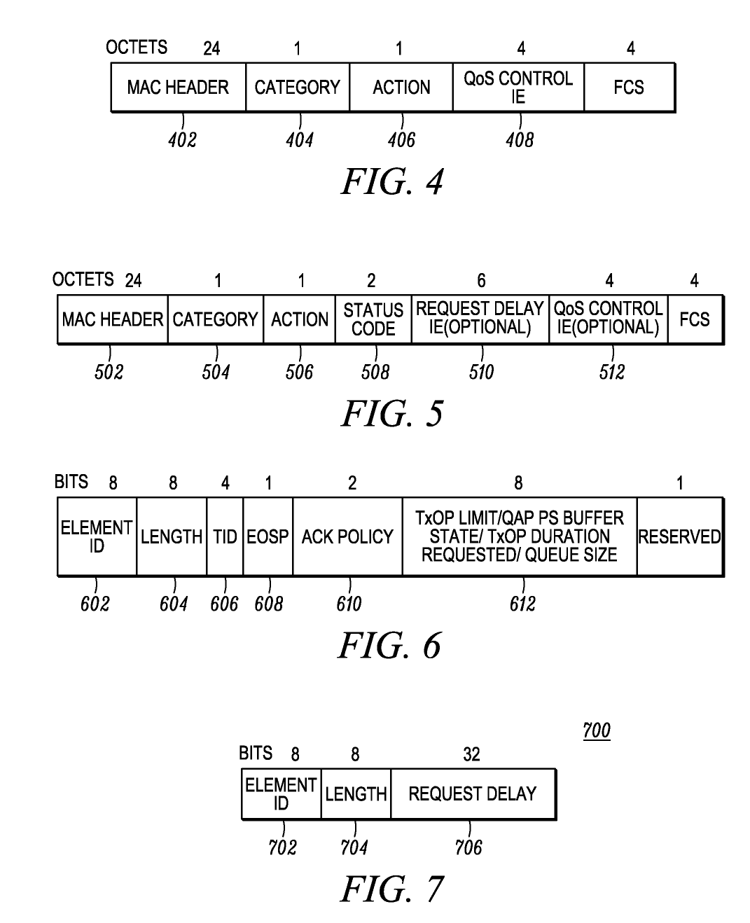

In an exemplary embodiment, the request 202, 302 for channel access (also termed message A) is shown in FIG. 4 and described below. As mentioned above, the function of the request 202, 302 is to allow the client to request a TxOP of a specified priority so the client can transmit upstream traffic. In one embodiment, the request 202, 302 may also specify the duration of a TxOP. In an alternative embodiment, the client may request 202, 302 a TxOP of a specified queue size (instead or in addition to specified duration). In such an embodiment, the client does not have to determine the duration and the AP calculates a duration based upon the specified queue size.

In any case, in one embodiment, the request 202, 302 adheres to a frame format specified for “Action” management frames in IEEE 802.11. As such, the request frame 202, 302 comprises a MAC header 402 that has a MAC address as specified in the standard and is known to one of ordinary skill in the art. Further, the request 202, 302 indicates that the frame is related to quality of service (QoS or QOS) by setting a category field 404 QoS. In one embodiment, the category field 404 is set to “1” to indicate the QoS category. Further, the action field 406 indicates the type of frames namely a TxOP request. Thus, in one embodiment, the action field is set to “254” to indicate the TxOP request.

Further, the request 202, 302 comprises a QoS control information element (IE) field 408 which indicates QoS related information. The QoS control TE held 408 is described below; however, for the request 202, 302 the client specifies either tat it is requesting a TxOP of a specified duration or a TxOP of a specified queue size. Further, the client also specifies the priority of the request as further described with reference to FIG. 6. Optionally, the request 202, 302 may also carry a Request Delay IE field (not shown) where the client specifies a duration that the client will wait before retrying an acknowledged TxOP request.

In an alternative embodiment, the request 202, 302 adheres to a frame format specified for QoS Null frames in IEEE 802.11. As such, the request frame 202, 302 utilizes a QoS Control sub-field in the MAC header for specifying the request. The client specified either that it is requesting a TxOP of a specified duration or a TxOP of a specified queue size. Further, the client also specifies the priority of the request as further described with reference to FIG. 6.

In an exemplary embodiment, the response 206, 306 to the request for channel access (also termed message C) is shown in FIG. 5 and described below. As mentioned above, the function of the response 206, 306 is to communicate the client rejection, access, modification of access, and/or delay of access to the channel. In an exemplary embodiment, the response is used primarily to reject the request for channel access.

In one embodiment, the response 206, 306 adheres to a frame format specified for “Action” management frames in IEEE 802.11. As such, the response frame 206, 306 comprises a MAC header 502 that has a MAC address as specified the standard and is known to one of ordinary skill in the art. Further, the response 206, 306 indicates that the frame is related to quality of service (QoS) by setting a category field 504 QoS. In one embodiment, the category field 504 is set to “1” to indicate the QoS category. Further, an action field 506 indicates the type of frame, namely a TxOP response. Thus, in one embodiment, the action field is set to “255” to indicate the TxOP response.

Further, the response 206, 306 comprises a status code 508 to indicate whether the request was rejected, accepted, modified, or delayed. For example, the field may be set to “255” to indicate that the request is denied. Further, he response 206, 306 comprises a request delay IE 510 to indicate a time that the client may retry the request. For example, the request delay IE 510 may indicate a time to wait before sending the request again. In an example, the AP may set this field to “0” to indicate that the client may wait an indeterminate amount of time before sending the request again. Further, the response 206, 306 comprises a QoS control information element (IE) field 512 which indicates QoS related information. The QoS control IE field 512 is described below; however, for the response 206. 306 the QoS control IF field 512 may carry information relating to a request that is accepted or modified.

In one embodiment, the acknowledgements 204, 208, 304 (also termed message B) adhere to an “ACK” frame format specified in IEEE 802.11 and is a frame comprising a MAC header of length 10-octets and FCS of length 4-octets. In an alternative embodiment, the acknowledgements 204, 208, 304 may also adhere to a frame format specified for “QoS CF ACK” as specified in IEEE 802.11. The alternative embodiment is not desirable since it is a larger frame and may waste capacity on the channel by requiring the larger frame.

In the embodiment where the grant of access to the channel is not signaled explicitly, the client may receive indication of the access to the channel by decoding the MAC header of the frames exchanged, e.g. 308. For example, in one embodiment, a QoS control TxOP limit field of the MAC header informs the client of the time remaining for channel access for the frames to be exchanged, e.g. 308. Further yet, if the time specified for channel access is insufficient for the client, the AP may specify that it will provide time at a later time for further access. By informing the client of the AP's intention to provide later time, the client may decide to stay awake until the next opportunity for channel access.

The another embodiment, the AP maintains knowledge of how much time is granted to each client. For example, the AP may not allow a first client more access to the channel than a second client. By keeping track of access to the channel, the AP prevents resource starvation among the clients. For example, a second request for the channel may be separated by time to allow a first request of the same priority to be handled before the second request. In such an embodiment, each client needs to transmit a new request 202, 302 only if a) the previous request 202, 302 was rejected, b) the previous request 202, 302 was not sufficient to process the upstream and downstream traffic of the client, or c) new traffic has arrived since the previous request 202, 302 was processed. Since the AP maintains knowledge of how much time is granted to each client, each client does not need to submit a new request 202, 302 if a previous request 202, 302 was partially fulfilled.

Further, the AP may use a frame format specified for “QoS CF Poll” as specified in IEEE 802.11 for performing the polling of the client before the frames are exchanged, e.g. 308.

In an exemplary embodiment, the QoS control IE 408, 512 functions to provide QoS information in the “Action” management frame where the “Action” management frame is specified in IEEE 802.11. Referring to FIG. 6, the QoS control IE 408, 512 comprises an element ID 602, a length 604, a TID (Traffic Identifier) 606, a EOSP (End Of Service Period) 608, an ack policy 610, an a TxOP Limit/QAP PS (QOS AP Power Save) Buffer State/TxOP Duration Requested/Queue Size 612. In an exemplary embodiment, the element ID 602 is set to “254” to indicate the TxOP and the length field is set to 2-octets to indicate the length of the QoS control IE 408, 512, in an exemplary embodiment, the TID 606 is set to the user priority of the reported TxOP Limit/QAP PS Buffer State/TxOP Duration Requested/Queue Size 612. In an exemplary embodiment, the EOSP 608 is used as one factor in selecting the information conveyed by the 612. In an exemplary embodiment, the TxOP Limit/QAP PS Buffer State/TxOP Duration Requested/Queue Size 612 is used to signal at least one of the four aforementioned information. A combination of the frame type/subtype that carries this E and the value of EOSP is used to determine which of these four options is being signaled as shown in below. In an exemplary embodiment, the client can set the value signaled to 0 to indicate that no upstream traffic is buffered but that the client is awake to retrieve unspecified amount of downstream traffic.

| | | TxOP Limit/ |
|---|---|---|
| | | QAP PS Buffer State/ |
| | | TxOP Duration |
| Frames | EOSP | Requested/Queue Size |
| Request | 0 | TxOP Duration |
| | | Requested |
| Request | 1 | Queue Size |
| Response | 0 | TxOP Limit |
| Response | 1 | QAP PS Buffer State |

In an exemplary embodiment, a Request Delay IE 700 functions to provide information relating to retry time. For example, the AP may indicate how long a client should wait before retrying a request, e.g. 202, 302 by sending the request delay IE 700. Another example, the client may indicate how long it will wait before retrying a request, e.g. 202, 302. In an exemplary embodiment, the request delay IE 700 comprises an element ID 702, a length 704, and a request delay 706. In an exemplary embodiment, the element ID 702 is set to “255” to indicate the TxOP and the length field is set to 4-octets to indicate the length of the Request 15 Delay IE 700. In an exemplary embodiment, the request delay 706 indicate the amount of recommended delay after which a client may retry its request, e.g. 202, 302.

As mentioned above, utilizing an embodiment of the channel access described herein provides power savings to clients in the meshed WLAN 100. In addition, utilizing an embodiment of the channel access described herein mitigates a “hidden terminal” problem as is known to one of ordinary skill in the art. By using the request and response as described above in the figures, there is less probability of collisions in the meshed WLAN 100 because the request and response messages as described herein are short messages, wherein short is defined as a length less than data frames. In one embodiment, the request, e.g. 2102, 302, is only 34 bytes long and a typical data packet is between 130-1500 bytes. In any case, because the request and response messages are short messages, there is a higher likelihood that the request and response message are received without errors. Further, since the access to the channel for data exchange is initiated by the AP, e.g. message C, the data in the meshed WLAN 1 is protected from the “hidden terminal” problem.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. For example, the subscriber unit and/or the base radio may comprise a storage medium having stored thereon a set of instructions which, when loaded into a hardware device (e.g., a microprocessor), causes the hardware device to perform the following functions of the present invention. The present invention can be implemented in at least one of hardware, firmware and/or software. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

It should be noted that the terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language).

We claim:

1. A method for providing a client access to a channel in a meshed wireless local area network comprising:
at a client in the meshed wireless local area network, wherein the meshed wireless area network implements a polling based channel access methodology:
determining that the channel is available by sensing that the channel is not busy;
sending a request for access to the channel to an access point, wherein the request specifies a priority of data wherein the data will be transmitted when the client is granted access to the channel; and
waiting a time period before receiving at least one of a) a rejection of the request for access to the channel, b) access to the channel, c) modification of the request for access to the channel, and d) delay access to the channel.

2. The method of claim 1 wherein the request further comprises at least one of a duration and a queue size.

3. The method of claim 1 wherein the time period accounts for at least one of a a) queuing delay, b) request processing time, c) channel access delay, and d) random wait time.

4. The method of claim 3 wherein the random wait time depends upon at least one of the priority of data, a number of received requests, and a time available to the access point to allocate transmit opportunities to requests.

5. The method of claim 3 wherein the random wait time accommodates a channel access delay of a request at a higher priority than the request.

6. The method of claim 1 further comprising sleeping when the rejection of the request for access to the channel is received,

7. The method of claim 1 wherein the request is a short proprietary signaling message.

8. The method of claim 1 wherein the determining adheres to an IEEE 802.11 standard for contention based access to the channel.

9. The method of claim 1 wherein the at least one of a) a rejection of the request for access to the channel, b) access to the channel, c) modification of the request for access to the channel, and d) delay access to the channel provides polling based access to the channel.

10. A method for providing a client access to a channel in a meshed wireless local area network comprising:
at an access point in the meshed wireless local area network, wherein the meshed wireless area network implements a polling based channel access methodology:
receiving a request for the channel from the client, wherein the request specifies a priority of data wherein the data will be transmitted when the client is granted access to the channel;
acknowledging the request, and
waiting for a time period before sending at least one of a) a rejection of the request for access to the channel, b) access to the channel, c) modification of the request for access to the channel, and d) delay access to the channel.

11. The method of claim 10 wherein the request further comprise at least one of a duration and a queue size.

12. The method of claim 10 wherein the time period accounts for at least one of a a) queuing delay, b) request processing time, c) channel access delay, and d) random wait time.

13. The method of claim 12 wherein the random wait time depends upon at least one of the priority of data, a number of received requests and a time available to the access point to allocate transmit opportunities to requests.

14. The method of claim 12 wherein the random wait time accommodates a channel access delay of a request at a higher priority than the request.

15. The method of claim 10 wherein the request is valid for a specified time period.

16. The method of claim 10 further comprising sending a response wherein the response is at least one of a) a rejection of the request for access to the channel, b) access to the channel, c) modification of the request for access to the channel, and d) delay access to the channel.

17. The method of claim 16 wherein the response contains a request delay information element to indicate a time that the client may retry the request.

18. The method of claim 10 wherein the request comprises a quality of service control information element.

19. The method of claim 10 wherein the request adheres to an IEEE 802.11 “Action” management frame format.

20. The method of claim 10 wherein the at least one of a) a rejection of the request for access to the channel, b) access to the channel, c) modification of the request for access to the channel and d) delay access to the channel is indicated by the access point initiating polling based access methodology that adheres to Hybrid Co-ordination Function Controlled Channel Access as specified in IEEE 802.
